(19) United States
(12) Patent Application Publication
(10) Pub. No.: US 2025/0385726 A1
(43) Pub. Date: Dec. 18, 2025

(54) COMMUNICATIONS SYSTEM AND VEHICLE FOR THE SAME

(71) Applicant: AVEALTO LTD., London (GB)

(72) Inventors: Carlos Gustavo GARDELLINI, Ixelles (BE); Matthias LAURICH, Owings Mills, MD (US); Simon SWIFT, Madley, Hereford and Worcester (GB); Manuel Esperon MIGUEZ, Isleworth (GB); Walter ANDERSON, London (GB)

(21) Appl. No.: 18/878,331

(22) PCT Filed: Jun. 28, 2023
(86) PCT No.: PCT/GB23/51684

§ 371 Date: Dec. 23, 2024

(30) Foreign Application Priority Data
Jun. 28, 2022 (GB) 2209473.4
Jun. 28, 2022 (GB) 2209474.2

(51) Int. Cl. H04B 7/185; H01Q 1/28; H01Q 3/08; H01Q 9/04; H01Q 15/14; H04L 5/00; H04W 72/0453

(52) U.S. Cl. CPC H04B 7/18504; H01Q 1/28; H01Q 3/08; H01Q 9/0407; H01Q 15/14; H04L 5/0044; H04W 72/0453

(57) ABSTRACT

A communications system comprising at least one vehicle, which, in use, is maintained at a substantially constant position at an altitude of 15 km to 22 km, and which comprises a communications payload for providing a communications relay service with a ground station within one or more or all of the C band, the X band, the Ku band, the K band, and the Ka band.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present disclosure relates to a communications system. In particular to a high-altitude pseudo satellite communications system.

### 2. Description of Related Art Including Information Disclosed Under 37 CFR 1.97 and 37 CFR 1.98.

The world is undergoing an extraordinary technological revolution in satellite and high-altitude communications. A dramatic increase in broadband capacity across the globe, spurred by new technologies is bringing the promise of reliable and affordable broadband connectivity to the hardest-to-reach corners of the Earth.

However, it is apparent that new technologies are required to enable new capabilities and applications in areas already connected to the global network, and to help drive down access costs for many people. Over 3 billion people do not have access to the Internet today and are essentially cut off from modern society and all the benefits of health, education, equality and financial stability and advancement that it can bring.

Due to their coverage, reliability, mobility, and flexibility, increasing consideration is being given to space-based technologies as a means of expanding the reach and density of the global Internet.

To date, however, no commercially viable solution has been implemented to allow for sufficiently widespread use.

Geosynchronous Orbit Satellites (GEOSats) orbit directly over the equator at an altitude of around 36,000 kilometers (22,000 miles). Their orbital speed allows them to remain over the exact same position as the earth turns. This allows a ground-based antenna to be fixed in position to send and receive radio signals to and from the satellite. A GEOSat now costs over US $350M to build and launch into geosynchronous orbit, with launch failures a constant risk. Most GEOSATs have an on orbit lifetime of around 8 to 12 years. GEOSats cannot be serviced or upgraded while on station. Due to the orbital distance from earth, a GEOSat signal will have a very high latency or propagation delay. This is highly noticeable on voice calls transmitted by satellite. This 500 millisecond (½ second) delay also reduces the effectiveness of error correction for data transmissions which can severely limit the capacity of Internet bandwidth.

Low Earth Orbit Satellites (LEOSats) travel in orbit closer to the earth. To maintain orbit they must travel at a higher speed and change their position relative to the ground very quickly. A LEOSat requires less signal strength to send a radio signal to the earth since it is orbiting closer to the earth than a GEOSat, however LEOSats support much less bandwidth than GEOSats. Moreover, a large number of LEOSats are needed to provide complete coverage so that one is always overhead. Current examples include Iridium and Globalstar, which each operate a constellation of LEOSats. Each LEOSat spends a large part of its orbit over areas where there are few or no potential users and can only provide a very small amount of bandwidth per satellite. More sophisticated LEOSats for telecom are being developed, but the cost of these networks will be many billions of dollars.

High Altitude Platform (HAP) vehicles are known. These unmanned vehicles, which may be airplanes or airships, fly above currently controlled airspace at an altitude of approximately 20 km. HAP vehicles are much lower in cost as compared to GEOSats and LEOSats. However, to date, no appropriate solution based on the use of HAP vehicles has been proposed.

### BRIEF SUMMARY OF THE INVENTION

The present invention arose in a bid to provide an improved communications system, which may be implemented in a cost-effective manner and address the shortcomings of the prior art.

Representative features are set out in the following clauses, which stand alone or may be combined, in any combination, with one or more features disclosed in the text and/or drawings of the specification.

According to the present invention in a first aspect, there is provided a communications system comprising at least one lighter than air vehicle, which, in use, is maintained at a substantially constant position at an altitude of 15 km to 22 km, and which comprises a communications payload for providing a communications relay service with a ground station within one or more or all of the C band, the X band, the Ku band, the K band, and the Ka band.

The communications system may be configured to provide a communications relay service in any possible combination of the stated bands, i.e., at any desired frequencies between 4 and 40 GHz.

By such a unique arrangement, there is provided a cost-effective alternative to prior art satellite communications systems. The altitude makes use of airspace that is not in widespread use, whilst also significantly reducing latency. The substantially constant position of the vehicle and use of a communications payload providing a communications relay service with a ground station within one or more or all of the C band, the X band, the Ku band, the K band, and the Ka band, allows the use of the system with existing satellite ground stations, without reconfiguration, the vehicle effectively mimicking a GEOSat.

The vehicle preferably remains within 500 m of a specific point in space. The vehicle more preferably remains within 250 m of a specific point in space.

The vehicle preferably maintains its position for at least 12 hours. It may maintain its position for at least 24 hours, at least a week, at least a month, or even at least a plurality of months.

The communications payload may be of “bent pipe” architecture, whereby the signal undergoes frequency translation, or may be regenerative, whereby the signal is received and re-generated. In either instance, the purpose is to emulate operation of a GEOSat.

The communications payload is preferably configured to transmit signals at a predetermined power level, such that when the signal reaches the receiver on the ground it has a power level equivalent to that of a signal received from a Geosynchronous Orbit Satellite. The power level will be determined using link budget calculations, as will be readily appreciated by those skilled in the art.

This signal strength matching with GEOSats has several benefits. The signal is not of a strength to overpower signals from such satellites. Moreover, the ground station receives signals without distinction between signals received from GEOSats or the vehicle of the present invention.

The communications payload may be configured to receive a signal at a first power level and to transmit the signal at a second power level that is lower than the first power level.

Since the received signal is travelling a far shorter distance to reach the vehicle than an equivalent signal received by GEOSats, the received signal at the vehicle has a greater signal strength. Accordingly, the communications payload may be arranged to transmit a signal at a reduced strength to the received signal, whilst matching the signal strength at the ground level of the transmitted signal of GEOSats at ground level.

The communications payload preferably comprises an antenna assembly comprising a patch antenna and a deflector for reducing sidelobe gain of the patch antenna, which projects from a plane of the patch antenna.

The deflector preferably substantially surrounds the patch antenna. The deflector may project from the plane of the patch antenna to an open mouth. The antenna may be substantially closed other than the open mouth.

The patch antenna is a low-profile antenna, which is substantially planar in form. It may be surface mountable. It is preferably fabricated on a printed circuit board or other substrate. The patch antenna may comprise an array of patches. The patch antenna may comprise a via-fed patch array antenna.

The use of a patch antenna allows for the transmission/receipt of signals on the same frequencies as GEOSats. The unique addition of the deflector allows for the use of such an antenna at far lower heights that GEOSats, whilst avoiding interference.

According to the present invention in a further aspect, there is provided an antenna array.

Preferably, an antenna array of the communications payload, which comprises a plurality of the antenna assemblies as defined above, is mounted to the vehicle via a three-axis gimbal for maintaining a substantially constant orientation of the antenna array relative to the ground station. Additionally or alternatively, the communications payload is preferably configured such that the ground transmit area covered by the vehicle can be modified by switching off one or more antennas of the array. Such an arrangement provides an effective means of reducing interference.

The vehicle is preferably a lighter than air vehicle. It is most preferably an airship. The communications system may comprise a plurality of the airships. Further, preferred, features are presented in the dependent claims.

### BRIEF DESCRIPTION OF THE SEVERAL VIEWS OF THE DRAWINGS

Non-limiting embodiments of the invention will now be discussed with reference to the following drawings.

FIGS. 1A and 1B show top and bottom perspective views of an airship for use in a communications system according to the present invention.

FIG. 2 shows a front elevation view of the airship of FIGS. 1A and 1B.

FIG. 3 shows a schematic view of a construction detail of an outer envelope of the airship of FIGS. 1A and 1B.

FIG. 4 shows a schematic view of an exemplary avionics system architecture for the airship of FIGS. 1A and 1B.

FIG. 5 shows a perspective view of an exemplary antenna assembly.

FIG. 6 shows a top plan view of the antenna assembly of FIG. 5.

FIG. 7 shows a side elevation view of the antenna assembly of FIG. 5.

FIG. 8 shows a bottom plan view of the antenna assembly of FIG. 5.

FIG. 9 shows a perspective view of an array of the antenna assemblies of FIG. 5.

FIG. 10 shows a top plan view of the array of FIG. 9.

FIG. 11 shows a schematic view of the airship comprising an antenna array mounted thereto via a three-axis gimbal, wherein the schematic is not to scale.

### DETAILED DESCRIPTION OF THE INVENTION

In broadest terms, there is provided a communications system comprising at least one lighter than air vehicle, which, in use, is maintained at a substantially constant position at an altitude of 15 km to 22 km, and which comprises a communications payload for providing a communications relay service with a ground station within one or more or all of the C band, the X band, the Ku band, the K band, and the Ka band.

The vehicle is preferably configured to maintain its substantially constant position for at least 12 hours. The vehicle is preferably configured to remain within 500 m of a predetermined point is space.

The communications system may comprise a plurality of the vehicles. It may, for example, include tens of the vehicles.

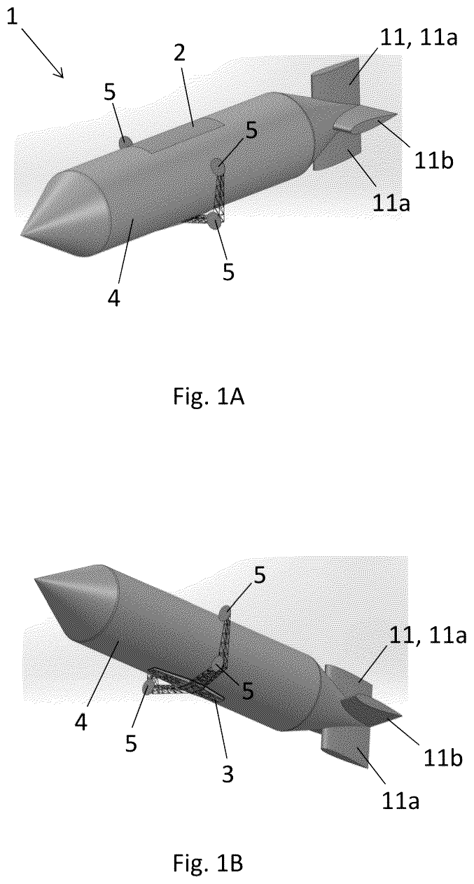

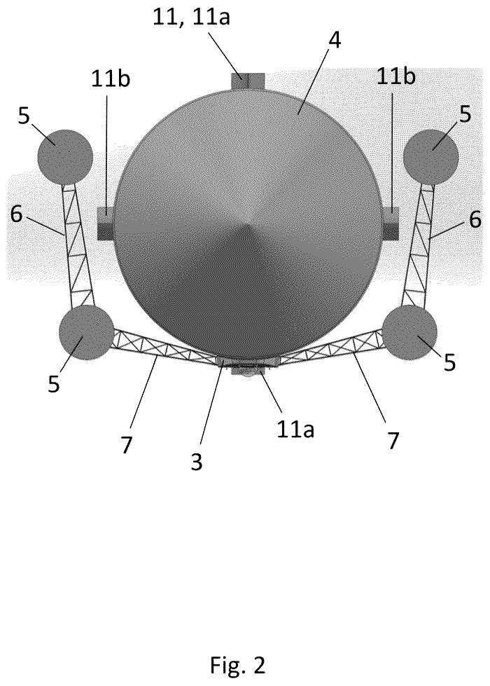

With reference to FIGS. 1A and 1B and 2, there is shown an airship 1 suitable for use in the system. Whilst an airship is the preferable form of vehicle and will be described in detail herein, it should be appreciated that alternative arrangements may be provided within the scope of the invention that comprise alternative vehicles, including lighter than air vehicles taking alternative forms.

The airship is preferably semi-rigid. It preferably uses helium as the lifting gas. It preferably uses electric motors and propellers to control its direction of travel and a buoyancy control system to control its altitude, rate of climb and descent, as discussed in further detail below.

It is preferably configured to perform up to multi-month missions and for such purposes is preferably provided with solar panels 2 for harvesting electricity during daylight hours. Batteries are preferably provided to store the generated electricity, wherein the batteries can be used to power all systems, payload and the electric motors during night hours.

A normal mission profile may involve the airship departing from an operating base and climbing to the desired operating altitude. The climb may take approximately 600 minutes. Once at the operating altitude, the airship will be positioned to the desired area of operation where it substantially maintains its altitude and position. During this time it performs its commercial operations i.e. operating its communications payload, and providing the communications relay service in the desired band(s).

The operating area will typically be over sparsely populated rural areas or over water.

During the climb and descent phase, in order to minimise potential disruption to manned aircraft operating below 15 km, the routes will be planned to remain clear of established airways structures. Time spent below 15 km will be limited to climb or descent and may preferably occur at night when manned aircraft operations are at their most infrequent.

Considering the airship in further detail, as discussed, it is preferably a semi-rigid gas airship.

It may comprise a stiff keel 3 supporting a main envelope 4 along at least a portion of its length direction/longitudinal axis. The stiff keel 3 preferably extends along a longitudinal centreline of the main envelope/hull on an underside thereof. It need not extend along the entire length of the outer envelope and it is most preferably shorter than the main envelope, as best seen in FIG. 1B.

The longitudinal keel 3 is used to provide structural rigidity to the envelope. It preferably houses batteries, avionics and radio frequency (RF) units, which form part of the communications payload. It further provides an attachment point for any desired payloads. It also provides a structure to which a mounting structure for the propulsion system may be attached.

The keel 3 is not particularly limited in form or construction, however, in a preferred arrangement, as shown, it comprises a welded aluminium structure. It could otherwise be formed using carbon fibre, or otherwise.

Whilst not to be limited as such, the propulsion system is preferably configured in accordance with the depicted arrangement, comprising four electric motors, which are spaced from one another to provide a pair of vertically spaced motors on either side of the hull, and which each drive a fixed pitch propeller. The combination of each motor and propeller may be considered to define a propulsion unit 5. The propulsion units 5 are illustrated schematically in the figures. The electric motors are preferably brushless.

The motors/propellers are preferably mounted such that their thrust vectors are fixed in the horizontal, i.e., fixed parallel to the longitudinal axis of the outer envelope/hull 4. The motors/propellors are all capable of forward and reverse thrust and are independently controlled. In the present arrangement, as is preferred, there are four motors provided, as follows:
Motor 1: Port side upper
Motor 2: Port side lower
Motor 3: Starboard upper
Motor 4: Starboard lower

The four motors in such configuration provide sufficient thrust at all operating altitudes to perform the required manoeuvring through a use of differential and asymmetric thrust. Independent motor control is achieved under the control of an electronic control system. A turn command will result in asymmetric thrust between port and starboard motors. A pitch command will result in differential thrust between upper and lower motors. A speed change command will result in a thrust change across all motors.

It should be appreciated that in alternative arrangements, the motors and/or propellors may be alternatively configured. For example, there may be additional motors provided. Regardless of the specific number of motors, the propellers may alternatively comprise variable pitch propellers.

A suitable mounting is provided to support the motors in their desired positions/orientations. The mounting is most preferably attached to/supported by the keel 3. In the present arrangement, the motors are mounted on two substantially vertical pylons 6, which pylons 6 are supported by substantially horizontal support arms 7 that extend in opposed directions from the keel 3 substantially perpendicular to a longitudinal axis of the keel (and hull). The arrangement is such as to provide the discussed vertically spaced pair of motors on either side of the hull. Motors 1 and 2 are provided on the port side and motors 3 and 4 are provided on the starboard side. The support arms 7 and pylons 6 may be unitarily formed or may be formed separately and fastened together. Regardless, they may be formed from a suitable lightweight material. They may be formed from aluminium or carbon fibre, for example.

It has been determined that motors having a maximum power output of 35 kW are suitable. However, alternatively specified motors may be used.

The hull 4 preferably has an outer envelope that is under high pressure to maintain the shape of the airship. Inside the outer envelope, there may be a plurality of inner envelopes used to contain the gas, most preferably helium, which provides the necessary buoyancy. In a preferred example, there are three inner envelopes provided.

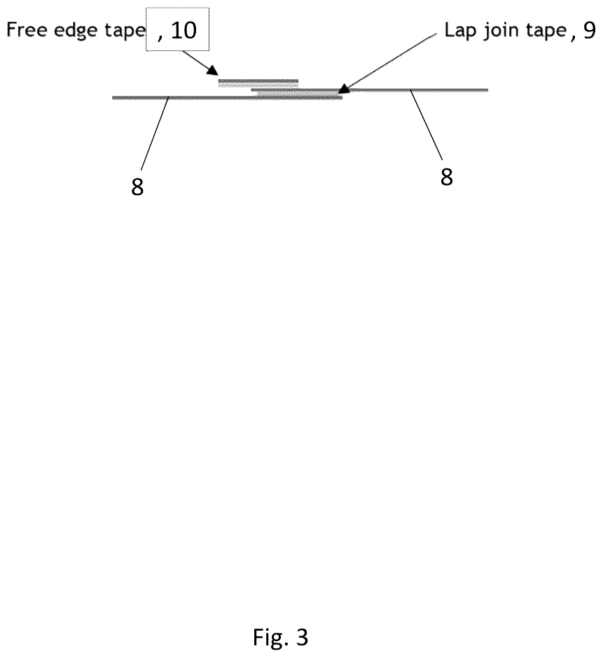

The inner and outer envelopes are each preferably formed from a number of gores 8, wherein each of the gores 8 comprises an appropriately shaped piece of material. The inner and outer layers may each comprise 20 or more gores. Adjacent gores 8 of any of the inner and outer envelopes may be joined to one another using a double-sided adhesive tape lap join 9. A single sided tape 10 may additionally be used to secure the outer free edge of the seam, as shown in FIG. 3.

It is preferable, for control of buoyancy that one or more ballonets (not shown) are provided. The ballonets comprise air bags. They are preferably contained within the outer envelope. In a preferred embodiment, a pair of ballonets is provided, one forward and one aft.

Fins 11 are attached to the aft envelope to provide dynamic and static stability. There are preferably four fins 11, as shown, with two vertical fins 11a and two horizontal fins 11b in a cross formation. They are preferably constructed of the outer envelope material and inflated by the super-pressure maintained within the outer envelope. The fins may be stabilised using cords, of Kevlar or other suitable material, attached to the ends of the fins at one end and to the envelope on the other. There may further be provided cords that connect the tips of each fin to both adjacent fins, which again may be Kevlar or otherwise.

The buoyancy of the airship is preferably controlled with an envelope pressure control system, which injects or ejects air from a plurality of ballonets that sit inside the outer envelope of the airship. The inflation/deflation of the ballonets will result in a change in the proportion of air and helium contained within the outer envelope. Increasing the proportion of air increases the average density of the gas contained in the airship, reducing its buoyancy. Ejecting air has the opposite effect, increasing the buoyancy of vehicle allowing it to gain altitude. The total volume of the envelope preferably remains almost constant.

The solar panels, which are preferably arranged on the upper surface of the airship, will, as discussed, be configured to provide sufficient electrical harvesting during daylight operating hours to enable propulsion and other system batteries to be sufficiently charged for operations overnight before commencing a new charging cycle the next day. The solar panels may, for example, have a surface area of 100 m2 or more.

Power is preferably derived from rechargeable batteries, which may take any suitable form.

Each motor may have its own individual power system comprising a battery and an Electronic Speed Controller (ESC).

Additional independent battery packs may be provided to provide power for the other electronic systems.

Whilst the dimensions of the airship are not particularly limited, a particularly preferred arrangement is configured as follows:
Length: 99 m
Span: 24.5 m
Height: 19.1 m
Maximum take-off and landing mass: 1965 kg

The airship will be sufficiently large (and buoyant) to support the required communications payload and associated power system. The airship will, as noted, may be around 100 m long. It is preferably at least 50 m long, more preferably at least 75 m long.

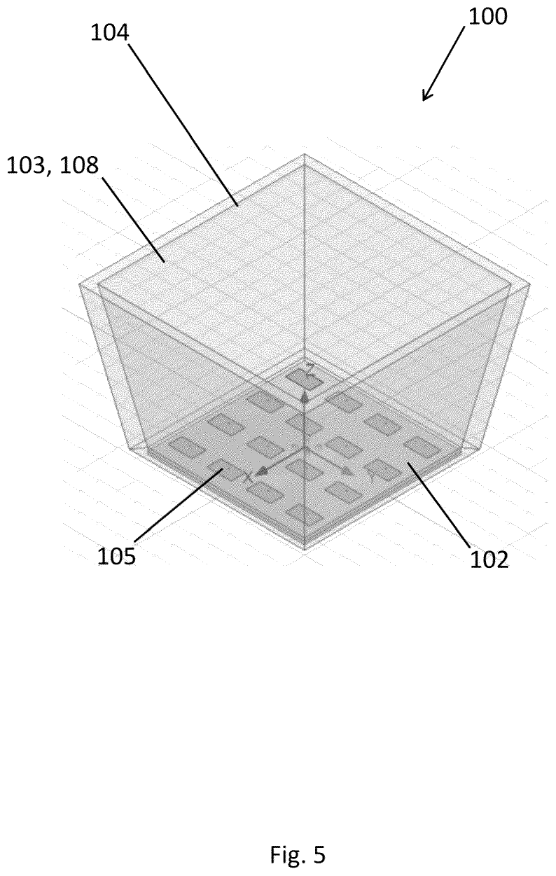

With reference to FIG. 5, an exemplary avionics system architecture is shown.

Air data sensors, such as but not limited to air speed and side slip sensors, and antennas intended for ground communications are preferably located on the keel. Antennas requiring satellite reception, such as but not limited to GPS and ADS-B antennas, are preferably located on the motor mounting pylons.

Navigation is preferably performed via a GPS system. It is preferable that a primary GPS system is provided that is supported by a redundant backup GPS system. The GPS system(s) preferably provide position information to an autopilot which sends the telemetry to a ground control.

A completely independent means of monitoring airship position is provided by an ADS-B (Automatic Dependent Surveillance-Broadcast) system. This system utilises a dedicated GPS receiver and barometer. Information transmitted by the ADS-B system is received by a space-based ADS-B receiver network and sent to the ground control via an Internet link.

The system preferably comprises primary and redundant backup autopilots. These preferably comprise the SC2 Autopilot available from Callen-Lenz Group.

Following launch, the vehicle will navigate under control of the autopilot to a predetermined location using the GPS and ADS-B systems. Upon reaching the desired location, the vehicle will loiter at that location, maintaining a substantially constant position by suitable operation of the buoyancy and propulsion systems under control of the autopilot. The substantially constant position preferably comprises any location within 500 m from a predetermined point in space. From the substantially constant position, the communications payload onboard the vehicle will provide a communications relay service with a ground station within one or more or all of the Ku band, the Ka band, the C band, the K band, or the X band. The vehicle may loiter at the predetermined location for any desired length of time. As discussed, this may, for example, be at least 12 hours. It could, however, be several months.

For ground antennas the telecoms payload behaves as a GEO satellite, meaning that the vehicle must stay at the same location while it is in operation. Since the vehicle is subjected to wind forces and changes in air density, the flight control system ensures that the vehicle loiters around the desired operation point. A vehicle loitering control ensures that the vehicle distance to the desired loitering point never exceeds a predetermined maximum distance, which may be 500 m.

The loitering control uses the three degrees of freedom as discussed above:
1) Altitude (z-axis displacement) is controlled using the buoyancy control system.
2) Yaw (z-axis rotation) is controlled using the electric motors with the motors on one side creating forward thrust and the motors on the opposite side creating backwards thrust.
3) Forward and reverse (x-axis displacement) is controlled with the electric motors. All four motors generate either forward or backward thrust to create forward or reverse motion respectively.

An exemplary control arrangement may be as follows:

A first, inner, sphere may be determined having a radius of up to 250 m from the predetermined point in space. A second, outer sphere, may further be determined having a radius of up to 500 m from the predetermined point in space. The position of the vehicle in relation to the predetermined point in space, and thereby in relation to the spheres, will be constantly monitored.
i) When it is determined that the vehicle is within the inner sphere, no action is necessary, however, the attitude control remains engaged to keep the payload levelled.
ii) When it is determined that the vehicle is outside the inner sphere but remains within the outer sphere—the airship rotates around its main axes to keep pointing to the predetermined point in space (i.e. the centre of the spheres) and uses forward or reverse thrust to return to the inner sphere.
iii) When it is determined that the vehicle is outside the outer sphere-the airship engages navigation mode to return to the inner sphere.

The communications payload is preferably supported by the keel. The communications payload may comprise a conventional geosynchronous orbit satellite transponder, appropriately configured to suit its use in the vehicle taking into account the desired operating height, and appropriate receipt and transmission frequencies and powers for mimicking of a ‘bent-pipe’ geosynchronous orbit satellite transponder at ground level.

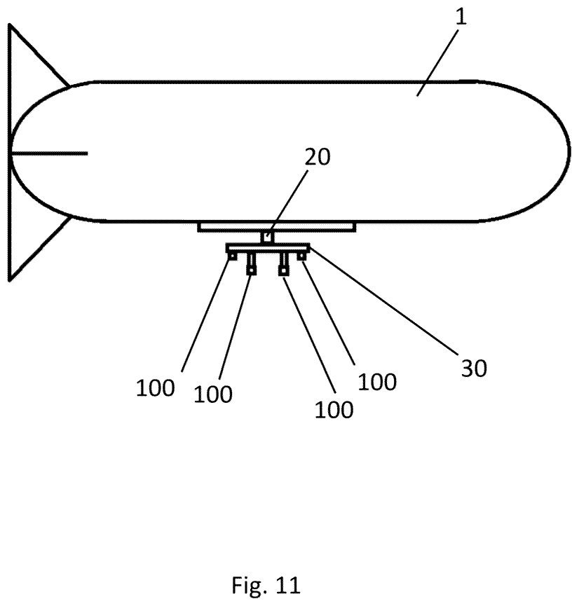

An antenna array of the communications payload is preferably mounted to the keel on an underside of the vehicle via a three-axis gimbal 20 (see FIG. 11). The three-axis gimbal 20 will maintain a substantially constant orientation of the antenna array relative to the ground station during use.

The antenna array may comprise a plurality of via-fed patch array antennas. The antennas are preferably mounted in a desired array, dependent on operating location and requirements. The antennas may be mounted on a support that is attached to the gimbal. The antennas may be arranged in an annular array. The support may be annular to suit the array. A first plurality of the antennas of the array may be configured to transmit signals and a second plurality of the antennas of the array may be configured to receive signals. The ground transmit area covered by the vehicle may be modified as necessary by switching off one or more antennas of the array.

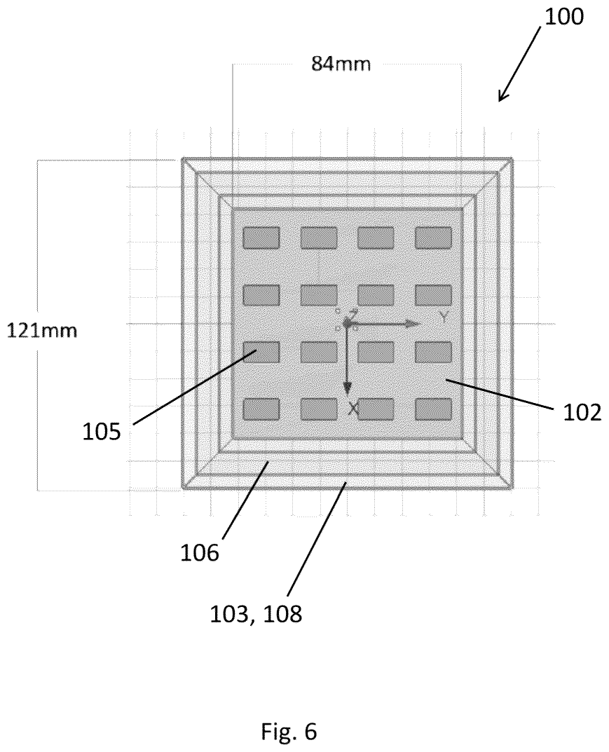

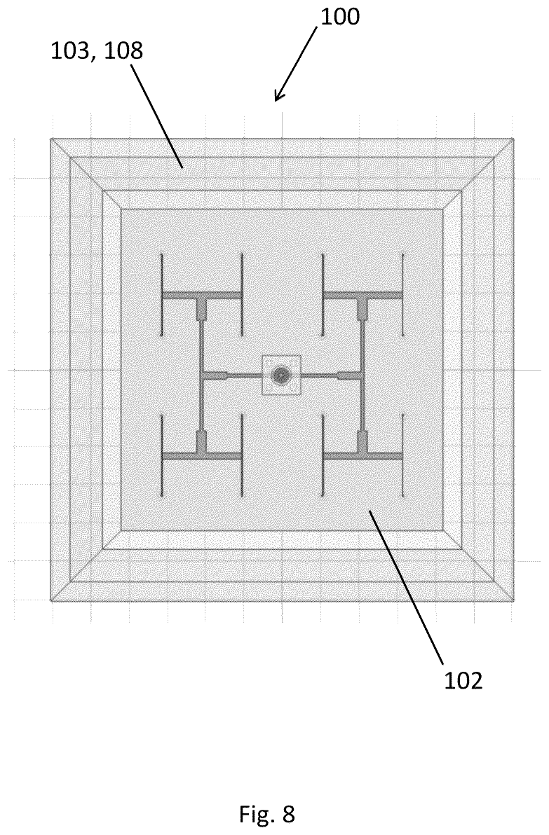

With reference to FIGS. 5 to 11, consideration will be given to a preferred antenna array.

FIGS. 5 to 8 show an antenna assembly 100 comprising a patch antenna 102 and a deflector 103. As shown, the deflector 103 projects from a plane of the patch antenna 102. In the present arrangement, the deflector 103 surrounds the patch antenna 102, i.e. surrounds an area of the antenna 102 comprising any/all patches 105. It projects from the plane of the patch antenna to an open mouth 104 defined by the deflector 103.

It should be appreciated that alternative arrangements are possible in which the deflector 103 does not surround the patch antenna 102. In such arrangements, the patch antenna 102 may, for example, extend along a part only of a periphery of an area of the antenna 102 comprising any/all patches 105.

As discussed, the patch antenna 102 is a low-profile antenna, which is substantially planar in form. It may be surface mountable. It is preferably fabricated on a printed circuited board, as shown. It may be otherwise manufactured and mounted on an alternative substrate. The patch antenna preferably comprises an array of patches 105. The patch antenna 102 in the depicted arrangement comprises a via-fed patch array antenna. In the present arrangement, a 4 by 4 array of patches is provided. As will be readily appreciated, however, alternative arrays may be implemented, which may comprise more or less patches 105. The 4 by 4 array is not limiting.

The deflector may be supported by and/or attached to the printed circuit board or substrate, as is the case in the present arrangement.

The patch antenna is preferably configured for receiving and/or transmitting signals in one or more of the Ku band, the Ka band, the C band, the K band, or the X band, most preferably in the Ku band.

The antenna assembly 100 is preferably substantially closed other than the open mouth. It is most preferably entirely closed other than the open mouth as in the depicted arrangement, with a continuous inner surface 106 extending between the patch antenna 102 and the open mouth.

The deflector may extend around the entire periphery of an area comprising any or all of the patches 105. In the present arrangement, as is preferred, the deflector extends around the entire periphery of the printed circuit board or substrate on which the patch antenna is fabricated. There may be a seal provided between the deflector and the printed circuit board, or substrate, which may be formed by adhesive.

By the antenna assembly being entirely closed other than the open mouth, it is meant that the arrangement is such that any signals transmitted from the patch antenna can only leave the antenna assembly through the mouth, and any signals received by the patch antenna can only enter the antenna assembly through the mouth.

In alternative arrangements, however, the deflector may not be substantially closed. For example, gaps may be provided between adjacent sidewalls that together define the deflector, or one or more sidewalls may be omitted, or provided at a different angle to adjacent sidewalls.

The deflector most preferably comprises one or more sidewalls 108. The sidewalls 108 may be considered to define petals. With gaps between the sidewalls, or one or more sidewalls omitted, one or more or all of the petals may be spaced from one another. With a closed arrangement, the petals may abut one another or be joined to one another either directly or indirectly.

In arrangements that are other than substantially closed, there could be a single sidewall or a number of sidewalls that do not substantially surround the patch antenna.

In the present arrangement the patch antenna has a substantially square profile with four antenna elements (or patches) and four sides. Here the profile is formed by bounding the smallest area containing all of the patches 105 with straight lines. It has sides of identical length. Such an arrangement is preferred but it should be appreciated that the profile of the patch antenna may take numerous other forms. It may have more or less sides, which may have the same length as one another or different lengths to one another. The sides could be square or curved. The profile of the patch antenna could have an entirely curved profile. The deflector may be adapted in accordance with the profile of the patch antenna. It may follow all or a portion of the profile.

It should be noted that the profile of the substrate may follow the profile of the patch antenna. Edges of the substrate could lie on the edges of the profile. However, the edges of the substrate will typically be spaced outwards therefrom, as in the depicted arrangement, such that the substrate has a larger surface area than a profile of the patch antenna thereon.

In the present arrangement, with a four-sided patch antenna, the deflector is formed by four sidewalls (or petals) 108. The sidewalls are preferably closed/solid and are preferably joined to one another along their adjacent edges to provide a continuous closed inner surface around the entire periphery of the patch antenna. Each of the sidewalls has a basal edge that is substantially the same length as a respective one of the side edges of the patch antenna that it extends along.

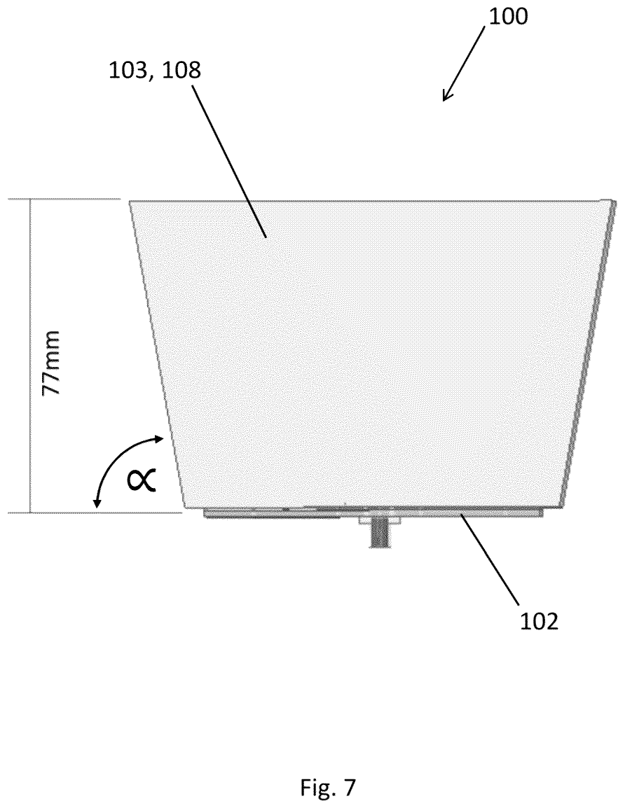

It is preferable that the deflector tapers from the periphery of the patch antenna. When there is an open mouth, the deflector preferably tapers out to the open mouth. By such an arrangement, the mouth has a larger surface area than the profile of the patch antenna. In the present arrangement, the taper a is best seen in FIGS. 5 and 7. The taper may be continuous or may vary. It is preferably continuous as in the present arrangement. The sidewalls are preferably straight between the periphery of the patch antenna and the open mouth. They could alternatively be curved or bent.

In the present arrangement, the sidewalls are all arranged at the same orientation as one another, however, this need not be the case. In some arrangements one or more of the sidewalls may be arranged at a different orientation to one or more of the other sidewalls. By way of non-limiting example, one sidewall could taper at a different angle to the remaining sidewalls, or all of the sidewalls could taper at different angles to one another.

The sidewalls may further be arranged such that one or more of the sidewalls has a different form to the remaining sidewalls, i.e. curved or bent versus straight, continuous taper versus variable taper, combinations of these alternatives, or otherwise.

Numerous alternatives/combinations within the variations considered above, and/or based on other possibilities, will be envisaged by those skilled in the art, wherein the specific arrangement implemented will be based on the specific operational requirements for a given deployment, as discussed further below.

The present invention is not to be limited to any particular arrangement.

It is preferred that the deflector is of fixed form. By such an arrangement, the taper/sidewall angle/orientation and form will be fixed. Such an arrangement allows for a very lightweight construction. The sidewalls will have their form and orientation set in dependence on the location in which the antenna is to be deployed. The deflector will reduce the antenna sidelobe gain at angles where interference with GEOSats may occur due to deployment location. The orientation may be set in dependence on the anticipated interference in any particular deployment location. Put differently, the antenna will be configured for use in a specific deployment location.

In the present arrangement, the angle of taper a of all the walls is 64 degrees. As noted above, the form and orientation of the sidewalls will be set in dependence on operational requirements in correspondence with a specific deployment. The taper of any one or more of the sidewalls may be anywhere from 0 degrees (i.e. one or more of the sidewalls may be parallel to the plane of the patch antenna) to 135 degrees (i.e. one or more or the sidewalls may taper inwards by up to 45 degrees). The sidewalls will typically taper at an angle of between 30 and 70 degrees. The taper (and form) of any of the sidewalls may be varied as required.

In alternative arrangements, the sidewalls may be reconfigurable. For example, the sidewalls may be mounted on actuators for altering the taper of the deflector. Suitable flexible or articulating joints may be provided between adjacent sidewalls to avoid gaps opening between sidewalls with movement of the sidewalls, however, these may not be necessary. With such an arrangement it would be possible to alter the deflectors remotely, i.e. during deployment for the purpose of fine tuning.

The size of the patch antenna is not particularly limited. It will be configured in dependence on operational requirements. However, it may have a surface area of 150×150 mm2 or less, preferably 100×100 mm2 or less, and most preferably 90×90 mm2 or less. Note that for other operational bands, the patch antenna dimensions are expected to be larger or smaller than existing preferred dimensions. The patch antenna will be adapted to operational requirements, as will be readily appreciated by those skilled in the art.

Again, whilst not particularly limited in size, and also dependent on operational requirements, the deflector may project from the patch antenna, in a direction perpendicular to a plane of the patch antenna by up to 150 mm or less, preferably 100 mm or less, most preferably 80 mm or less. It should be noted that where the deflector comprises a plurality of sidewalls one or more of the sidewalls may project by a different distance to one or more of the other sidewalls, or all sidewalls may project by the same distance. Note that for other operational bands, the deflector dimensions are expected to be larger or smaller than existing preferred dimensions. The deflector will be adapted to operational requirements, as discussed above, and will be readily appreciated by those skilled in the art.

As will be appreciated by those skilled in the art, the deflector may be formed from a range of materials. The material of the deflector may itself be reflective to signals in one or more of the Ku band, the Ka band, the C band, the K band, or the X band, or the inner surface 6 of the deflector may be coated with a suitably reflective material. Any arrangement that is effective for reducing the antenna sidelobe gain at angles where interference with GEOSats may occur due to deployment location of the antenna may be implemented, as will be readily appreciated by those skilled in the art. By way of non-limiting example, the deflector, or any sidewalls (or petals) thereof, may be formed by 3-D printing with a conductive material, 3-D printing with an absorptive material, 3-D printing and applying a conductive or absorptive material to a surface of the print, joining together substrates, which may comprise PCBs by soldering or otherwise, metal forming, by folding or otherwise, forming from a foam/substrate laminate with or without a reflective or absorptive coating applied thereto.

The deflector may be unitarily formed or may be formed from a number of separate parts.

The vehicle will most preferably comprise a number of the antenna devices arranged in an array. Most preferably a first plurality of the antenna assemblies of the array will be configured to transmit signals and a second plurality of the antenna assemblies of the array will be configured to receive signals. The numbers of antenna assemblies in the array and their configuration may be varied in dependence on the specific configuration of those assemblies and the operational requirements.

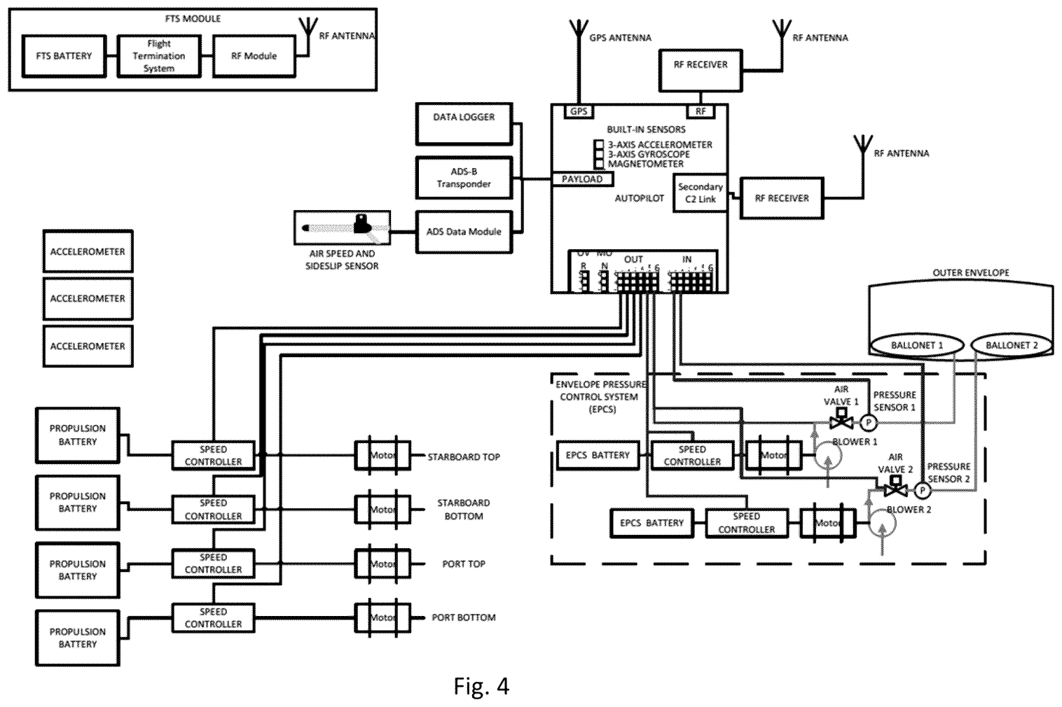

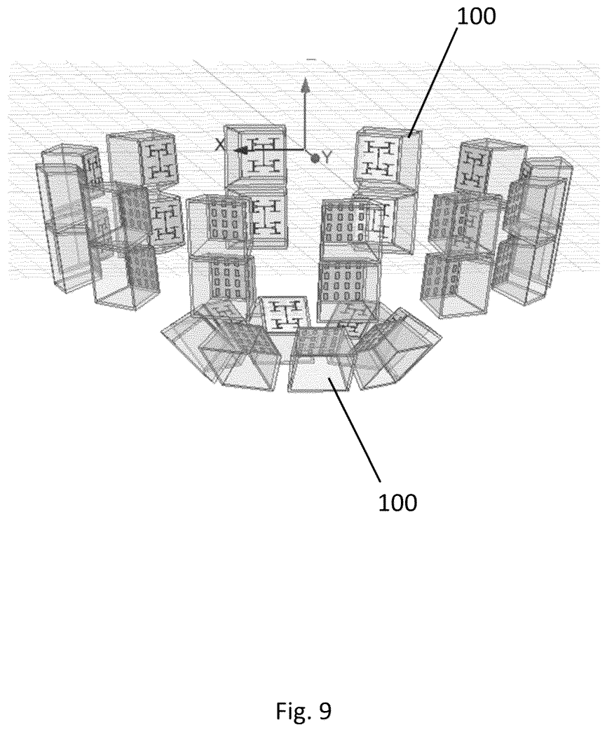

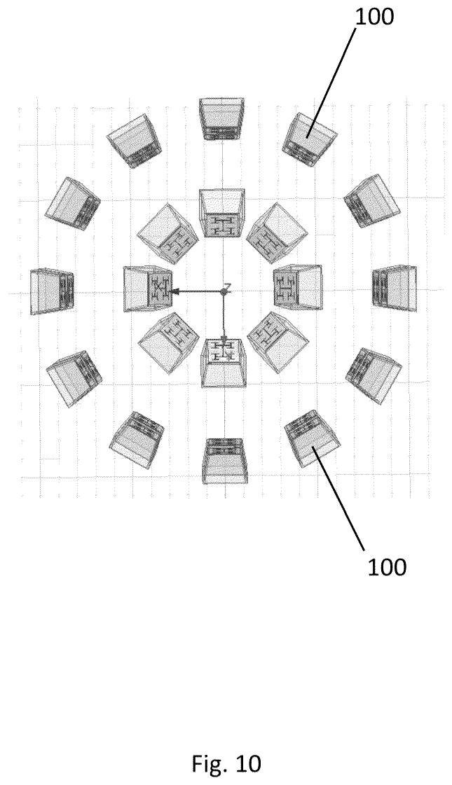

With reference to FIGS. 9 and 10, there is shown a non-limiting arrangement, comprising an antenna array that includes a plurality of antenna assemblies in accordance with the depicted arrangement of FIGS. 1 to 4. In this array there are provided 32 of the antenna assemblies, with 16 of the antenna assemblies arranged to transmit signals and 16 of the antenna assemblies arranged to receive signals. As stated, more or less of the antenna assemblies 100 may be used in any such array, which may be modified in any manner as discussed herein.

The antenna assemblies 100 are provided in an annular array. In alternative arrangements, they may be otherwise arranged. For example, they could be provided in a rectangular array, or otherwise.

The antenna assemblies 100 forming the array will be mounted to a suitable support, subframe or substructure, which may take any suitable form and be appropriately tailored to the array to be supported thereby, as will be readily appreciated by those skilled in the art. In the depicted arrangement, a substantially annular support may be used.

The antennas may be arranged in a plurality of rows. In the present, non-limiting example, three rows of antenna assemblies are provided.

As noted above, the antenna array is preferably mounted via a three-axis gimbal 20, as seen schematically in FIG. 11, for maintaining a substantially constant orientation of the antenna array during use.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

We claim:

1. A communications system, comprising:
at least one lighter than air vehicle, which, in use, is maintained at a substantially constant position at an altitude of 15 km to 22 km,
wherein the vehicle comprises a communications payload for providing a communications relay service with a ground station within one or more or all of the C band, the X band, the Ku band, the K band, and the Ka band.

2. The communications system as claimed in claim 1, wherein the vehicle is configured to maintain its substantially constant position for at least 12 hours.

3. The communications system as claimed in claim 1, wherein the vehicle is configured to remain within 500 m of a predetermined point in space.

4. The communications system as claimed in claim 1, wherein the communications payload comprises a converter which is arranged to change the frequency of received signals to a different frequency for onward transmission by the communications payload.

5. The communications system as claimed in claim 1, wherein the communications payload is configured to transmit signals at a predetermined power level, such that when the signal reaches the receiver on the ground it has a power level equivalent to that of a signal received from a Geosynchronous Orbit Satellite or a Low Earth Orbit Satellite.

6. The communications system as claimed in claim 1, wherein the communications payload comprises at least one antenna assembly comprising a patch antenna and a deflector for reducing sidelobe gain of the patch antenna, which projects from a plane of the patch antenna.

7. The communications system as claimed in claim 6, wherein the deflector projects from the plane of the patch antenna to an open mouth, and is substantially closed other than the open mouth.

8. The communications system as claimed in claim 1, wherein an antenna array of the communications payload is mounted to the vehicle via a three-axis gimbal for maintaining a substantially constant orientation of the antenna array relative to the ground station.

9. The communications system as claimed in claim 8, wherein the communications payload is configured such that the ground transmit area covered by the vehicle can be modified by switching off one or more antennas of the array.

10. (canceled)

11. The communications system as claimed in any preceding claim, wherein the vehicle comprises an electric propulsion system.

12. The communications system as claimed in claim 10, wherein the electric propulsion system comprises a plurality of independently controlled electric motors.

13. (canceled)

14. The communications system as claimed in claim 12, wherein the electric propulsion system is the exclusive steering mechanism of the vehicle, and is configured to steer the vehicle by differential control of two or more of the electric motors.

15. The communications system as claimed in claim 12, wherein at least two vertically spaced electric motors are provided either side of a longitudinal centreline of a hull of the vehicle.

16. The communications system as claimed in claim 12, wherein the vehicle comprises a rigid keel extending in a longitudinal direction, which supports a motor mount that supports the electric motors.

17. The communications system as claimed in claim 1, wherein stabilising fins are attached to a rear of the vehicle.

18. The communications system as claimed in claim 17, wherein there are four fins provided, which comprise two vertical fins and two horizontal fins.

19. The communications system as claimed in claim 16, wherein the fins are inflatable.

20. The communications system as claimed in claim 1, wherein the vehicle comprises a buoyancy control system, which comprises a plurality of inflatable ballonets, which are contained within an outer envelope of the vehicle, and an envelope pressure control system, which is arranged to inject or eject air from the ballonets.

21. The communications system as claimed in claim 20, wherein at least one ballonet is provided adjacent a front of the vehicle and at least one ballonet is provided adjacent a rear of the vehicle.

22. The communications system as claimed in claim 21, wherein the envelope pressure control system is arranged to independently control inflation/deflation of the front and rear ballonets.

23-24. (canceled)
